(19) United States
(12) Patent Application Publication
(10) Pub. No.: US 2008/0215675 A1
(43) Pub. Date: Sep. 4, 2008

(54) Method and system for secured syndication of applications and applications' data

(75) Inventors: Shahar Kaminitz, Savyon (IL); Yuval Tarsi, Kfar Saba (IL); Artem Spector, Rishon Letziyon (IL)

Correspondence Address: NIXON & VANDERHYE, PC, 901 NORTH GLEBE ROAD, 11TH FLOOR, ARLINGTON, VA, 22203, US

(73) Assignee: WORKLIGHT LTD., Yakum (IL)

(21) Appl. No.: 12/068,008

(22) Filed: Jan. 31, 2008

Related U.S. Application Data
(60) Provisional application No. 60/887,623, filed on Feb. 1, 2007.

(51) Int. Cl. G06F 15/16

(52) U.S. Cl. 709/203

(57) ABSTRACT

The present invention provides a new syndication system allowing secure syndication of applications in conventional web aggregators of authorized users, and allowing secured and controlled access to privileged content by means of the syndicated applications. The system of the invention advantageously employs conventional web syndication servers and aggregators thereby allowing authorized users to securely add applications and access privileged content via their favorable web aggregation sites (e.g., personalized web pages) along with other non-privileged content syndicated therein.

### CROSS REFERENCE TO RELATED APPLICATIONS

This application is based upon and claims the benefit of priority from the prior U.S. Provisional Patent Application Ser. No. 60/887,623, filed on Feb. 1, 2007, the entire content of which is incorporated herein by reference.

### FIELD OF THE INVENTION

The present invention generally relates to secured web syndication of privileged information, applications and application's data. More particularly, the invention relates to a method and system for allowing authorized users to access privileged information, applications and their data by means of conventional web syndication tools.

### BACKGROUND OF THE INVENTION

Many Web sites offer nowadays the ability to aggregate information and applications from different providers into a single personalized web page. These aggregation sites typically define a set of specifications to which syndicated applications must conform and provide services to application developers to ease the development of conforming applications. Examples of some current popular aggregation sites are iGoogle (http://www.google.com/ig), NetVibes (http://www.netvibes.com) and Microsoft Live (http://www.live.com).

FIG. 1 is a block diagram demonstrating a typical application syndication employing an aggregation site server 10 and web browser 15 used by a user (not shown) for downloading and running syndicated applications 16 by means of personalized web page 17. The aggregation site servers 10 typically provide the following services:

1. Application provisioning (11)—this service enables users to easily add syndicated applications 16 to their personalized web pages 17 and remove such syndicated applications 16 from it. Adding a syndicated application 16 to a personalized web page 17 usually involves following a URL (Universal Resource Locator) that conforms to URL specifications defined by the aggregation site provider. The URL includes information concerning the location wherein files describing the application (i.e., metadata, such as application name, description, author, version, date published, etc.) can be found. This URL is sometimes termed an ‘add-to URL’. Removing a syndicated application 16 from the personalized web page 17 is typically accomplished through the user interface provided in the personalized page 17 itself.
2. Data persistence (12)—this service enables syndicated applications 16 to store data across sessions of a web browser 15, during which syndicated applications 16 were accessed. The data persistence services 12 stores data per user on the aggregation site's servers 10.
3. Data retrieval (13)—this service enables syndicated applications 16 to request resources from the Web through the aggregation site's servers 10. This is especially useful in the case of syndicated applications 16 that run within the web browser 17, such as, for example, applications implemented in JavaScript or Flash. The access of such syndicated applications 16 to external resources (outside of their origin domain) is typically prevented due to security restrictions enforced by the default configuration of all major Web browsers (the ‘same origin policy’). Data retrieved by data retrieval services 13 of aggregation site 10 are typically cached in the aggregation site server 10, such that subsequent requests for the same data may be served by accessing the cache of the aggregation site server 10 directly.

Aggregation site servers 10 also provide many additional services, such as for example, services for controlling the size of the area in which syndicated applications 16 are displayed in the personalized web pages 17, services for controlling the titles of syndicated applications 16, and services for opening pop-up windows, and many more.

In order to keep the personalized web pages 17 personal, aggregation site servers 10 also perform user authentication. This is usually achieved by requesting the user to provide identifiers, typically in the form of user name and password. Most aggregation site servers 10 store a persistent cookie (not shown) on the user's web browser 15 in order to avoid requiring user authentication at the start of every session.

Aggregation sites are becoming popular Web destinations due to the fact that they allow users to easily build a personalized web page that contains the information that is most relevant to the users, and the syndicated applications that are most useful to them. Typically, this personalized web page then becomes the source for much of the information the users consume on a daily basis, such as news headlines, weather forecasts and sports scores, as well as the starting point from which they access other Web sites.

Applications syndicated on aggregation sites are very well suited for providing personalized access to information and functionality, but due to some features of aggregation sites, syndicated applications do not provide a good solution when a high level of security is required. A good example of an application that requires a high level of security is a syndicated application that provides access to a user's bank account. Some of the reasons for which syndicated applications are not considered appropriate when a high level of security is required are:

1. The level of authentication provided by the aggregation site servers 10 is insufficient since:
a. Aggregation site servers 10 do not require authentication every time a session is started;
b. Aggregation site servers 10 do not enforce session time outs;
c. Aggregation site servers 10 do not require periodic password changes;
d. Aggregation site servers 10 do not enforce high-entropy passwords;
e. Aggregation site servers 10 do not require ‘real-world’ credential to verify user's identity.
   2. Management of data stored in the aggregation site server's cache:
a. The data in the aggregation site server's cache persisted by the persistence services 12 is beyond the control of the application providers 1; and
b. The data retrieved by the data retrieval services 13 and stored in the aggregation site server's cache is beyond the control of the application providers 1.
   3. In some cases, aggregation site servers 10 serve the syndicated application's code itself off of their own servers, outside the application provider's control.
   4. Once an application is available for syndication the application provider 1 has no control over which users add the application to their personalized web page 17.

A secured web syndication scheme is described and claimed in co-pending U.S. patent application Ser. No. 11/896,740 of the same assignee hereof, the content of which is incorporated herein by reference. In this application modified web feeds and dedicated web servers are used for implementing a modified web syndication scheme allowing authenticated users to access privileged content by means of conventional web syndication clients.

The methods described above have not yet provided satisfactory solutions for allowing authorized users secured access to privileged content, applications and application's data over data networks by means of conventional web syndication.

It is therefore an object of the present invention to provide a system and method for providing authorized users secured access to privileged content and to syndicated applications designed for handling privileged content.

It is another object of the present invention to provide a uniform method for developing, deploying and running syndicated applications independent of the details of the aggregation site.

Other objects and advantages of the invention will become apparent as the description proceeds.

### SUMMARY OF THE INVENTION

The present invention provides a system and method for secure application syndication, and for securely accessing privileged content by means of syndicated applications, by conventional web aggregation means.

The term aggregation site is used herein to refer to aggregators of syndicated data and application, such as, but not limited to, personalized web pages, RSS aggregators and social networking sites. The term aggregation site server is used herein to refer to a sever capable of maintaining syndicated data and syndicated applications and allowing users to access the same over a data network (Such as iGoogle, NetVibes, Facebook, My Yahoo).

The term privileged content (also referred to herein as privileged data or information) is used herein to refer to classified information which may be accessed by authorized individuals only. The privileged content may comprise, but is not limited to, private, sensitive, confidential, and/or proprietary information.

The term secured network refers to a data network comprising security infrastructures (e.g., firewall) capable of preventing access of unauthorized users to the network resources. The security infrastructures preferably comprise means (e.g., Single sign on and authentication systems such as, but not limited to, Kerberos, and user directories such as, but not limited to, Active Directory) for authenticating users operating within the network and users attempting to access said network from external networks.

The term metadata used herein refers to data used for describing data items, such as, for example, title, author, version and date, of a content or application.

The term syndicated application used herein to refer to an application that is designed to be accessed within the context of an aggregation site. The aggregation site is typically provided by a party other than the syndicated application provider, and may aggregate syndicated applications from multiple providers.

The term application wrapper is used herein to refer to a file or set of files that describe a syndicated application and conform to the specifications defined by a specific aggregation site provider. The application wrapper contains information such as the application name and description, date published, author name etc. The application wrapper also contains a network address (URL in the WWW context) that references the syndicated application code.

The inventors of the present invention developed a new syndication system allowing secure syndication of applications in conventional web aggregators of authorized users, and allowing secured and controlled access to privileged content by means of the syndicated applications. The system of the invention advantageously employs conventional web syndication servers and aggregators thereby allowing authorized users to securely add applications and access privileged content via their favorable web aggregation sites (e.g., personalized web pages) along with other non-privileged content syndicated therein.

In general, the secured application syndication of the invention utilizes existing web clients (e.g., web browsers) and servers for securely adding a syndicated application to a web syndication site of an authorized user, wherein the syndicated application is provided over a secured connection by an application server maintained within a secure network responsive to identifiers and/or referencing data obtained in an application wrapper, wherein said application wrapper is provided by a provisioning server capable of generating and providing such application wrappers in response to user's requests containing unique identifiers referencing the requested applications and the users requesting the applications, which requests are received by the provisioning server via the aggregation site servers used by the users.

Preferably, the application server is maintained within a secured network of the application provider. Optionally, the application syndication process is initiated by the application server by providing the web client of the users addressing data comprising a link (i.e., network address) to the provisioning server, an identifier associated with the requested syndicated application, and optionally data referencing the aggregation site to which the syndicated application should be added. Preferably, the addressing data is provided in a form of an add-to URL. Advantageously, the secured network of the application provider further comprises information systems accessible by the syndicated applications provided by the application provider over the secured data connection.

The application syndication and/or communication of privileged data in the system of the invention is preferably performed after performing server, web client and user authentications. The server may be authenticated by the web client by means of SSL and digital certificates. The server may be authenticated by the user by means of an authentication phrase. Preferably, the user is authenticated by the application server by means of user name and password.

The system may comprise a personalized web client generated by a secured provisioning application (e.g., web application such as a secure banking application or a special purpose secure client provisioning application) by requesting a client identifier and/or key (e.g., cryptographic key), by the secured provisioning application, from the application server, and upon receipt of the client identifier and/or key generating the personalized web client by the provisioning application.

The authentication of the personalized web client by the application server may comprise execution of a challenge-response protocol by the server and the client, employing the client's key as the shared secret, which may be initiated by the client sending its client identifier to the application server.

Preferably, the application server comprises: the syndicated applications; means for authenticating the users and the user's clients; data persistence means for persisting data across aggregation site sessions; retrieval means for allowing the syndicated applications to request network resources through the application provider's servers; cache memory for storing data which has been previously requested by syndicated applications; serving means for serving incoming requests for data; data collecting means capable of periodically and/or continuously retrieving (privileged or non-privileged) data from the information systems; data transformation means for providing the data retrieved from the information systems in a proper data representation (e.g., RSS, JSON, XML); and optionally data consistency means for verifying that the data items stored in the cache is updated with the last changes made in the information systems. Advantageously, the data collecting means may be implemented by data adapters (e.g., MQSeries, RDBMS).

In one aspect the present invention is directed to a syndication system for securely adding syndicated applications to conventional syndication aggregation sites and servers being accessible by user's client applications, comprising: an application server adapted to provide said syndicated applications to said client applications of authenticated users, one or more secured communication links between said client applications and said application server, and a provisioning server capable of generating and providing said syndication aggregation sites an application wrapper responsive to a request from user's client application, wherein said request and said application wrapper comprise unique identifiers referencing the requested application and the user requesting the applications. Advantageously, the application server resides within a secured network.

The syndication system may further comprise one or more information systems residing within the secured network and capable of being accessed by the syndicated applications via the application server.

The application server may comprise the syndicated applications, means for authenticating the users and the user's client applications, data persistence means for persisting data across aggregation site sessions, retrieval means for allowing the syndicated applications to request network resources through said application server, cache memory for storing data which has been previously requested by syndicated applications, serving means for serving incoming requests for data, and data collecting means (e.g., data adapters) capable of periodically and/or continuously retrieving privileged, or non-privileged, data from the information systems.

Optionally, the application server may further comprise transformation means for providing the data retrieved from the information systems in a proper data representation, and/or data consistency means for verifying that the data items stored in the cache are updated with the last changes made in the information systems.

In another aspect the present invention is directed to a method for securely adding a syndicated application to user's aggregation site maintained in an aggregation site server and being accessible by a user client application, comprising: providing said client application addressing data (e.g., add-to URL) comprising a link (network address) to a provisioning server and identifiers associated with said user and with said syndicated application; providing said aggregation site server a request to add said syndicated application, wherein said request comprises said addressing data and said identifiers; forwarding said request to said provisioning server; upon receipt of said request by said provisioning sever generating an application wrapper comprising said identifiers and addressing data (e.g., network address) referencing a location of said syndicated application in an application server; providing said application wrapper to said aggregation site server; and determining whether said user is an authorized user, and if so adding said application wrapper to said aggregation site, thereby allowing said client application to fetch said syndicated application over a secured link connecting it to said application server, according to the data contained in said application wrapper.

Preferably, the addressing data is provided by the application server.

Optionally, the request further comprises data referencing the aggregation site to which the syndicated application should be added.

Preferably, the application server resides within a secured network. Advantageously the secured network further comprises information systems accessible by the syndicated applications provided by the application provider over the secured data connection.

Preferably, the communication between the client application and the application provider is performed after authenticating the client application, the application server, and the user. The server authentication may be performed by the client application, for example, by means of SSL and digital certificates. The server authentication may be performed by the user, for example, by means of an authentication phrase. The user may be authenticated by the application server by means of user name and password.

Optionally, the client application is a personalized client generated by a secured provisioning application by means of a client identifier and/or key provided by the application server. Advantageously, the authentication of the personalized client by the application server may comprise execution of a challenge-response protocol by the server and the client, employing the key as the shared secret.

### BRIEF DESCRIPTION OF THE DRAWINGS

The present invention is illustrated by way of example in the accompanying drawings, in which similar references consistently indicate similar elements, and in which:

FIG. 1 is a block diagram schematically illustrating conventional application syndication systems;

FIG. 2 is a block diagram illustrating the data flow in a typical syndication system of the invention;

FIGS. 3A and 3B are block diagrams schematically illustrating components in a syndication system of the invention, wherein FIG. 3A shows a general structure of the syndication system and FIG. 3B shown general structure of an adapter component;

FIG. 4 is a flow chart illustrating a possible data consistency verification process of the invention;

FIG. 5 schematically illustrates a possible authentication sequence between a user, user's client, and a web server;

FIG. 6 schematically illustrates possible client instance identifier provisioning and client authentication processes;

FIG. 7 is a block diagram schematically illustrating a preferred embodiment of a syndicated system of the invention;

FIG. 8 exemplifies a possible application wrapper for the iGoogle aggregation site;

FIG. 9 is a flowchart illustrating a possible provisioning process of the invention;

FIG. 10 is a flowchart illustrating a possible user authentication process;

FIG. 11 exemplifies a possible syndicated application;

FIG. 12 exemplifies addressing privileged content by means of a URL;

FIGS. 13A and 13B exemplify data retrieval in HTML representation, wherein FIG. 13A exemplifies a request for the HTML representation of data and FIG. 13B exemplifies possible provisioning of the requested data in HTML representation;

FIGS. 14A and 14B exemplify data retrieval employing RSS feeds, wherein FIG. 14A exemplifies an RSS item and FIG. 14B exemplifies a possible RSS feed employed for providing the requested data;

FIGS. 14C and 14D exemplify data retrieval in XML representation, wherein FIG. 14C exemplifies a request for the XML representation of data and FIG. 14D exemplifies possible provisioning of the requested data in XML representation;

FIG. 15 exemplifies possible URL referencing of a set of data items;

FIG. 16 shows a possible mashup application in the syndication system of the invention;

FIGS. 17A and 17B exemplify possible access control scheme in the syndication system of the invention, wherein FIG. 17A shows an exemplary customer database and FIG. 17B shows the data items association in the system's cache; and

FIGS. 18A to 18C exemplify removal of malicious scripts from retrieved data.

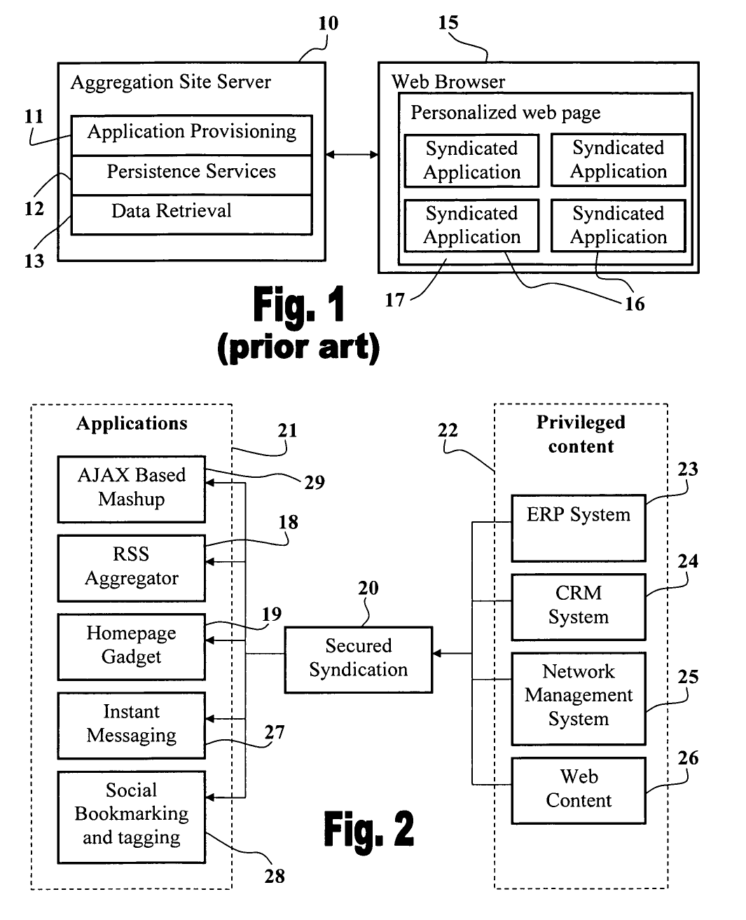

### DETAILED DESCRIPTION OF PREFERRED EMBODIMENTS

The present invention provides a system and method that enables access to privileged application data, and secure provisioning of syndicated applications adapted to handle such privileged data, by means of conventional web-technologies, such as, for example, Web 2.0 technologies. The goals of the invention are accomplished while maintaining the security, scalability and reliability required in many organizations, for example, enterprise systems. As demonstrated in FIG. 2, the secured syndication scheme 20 provided by the present invention allows users' syndicated applications 21 to access privileged content 22 available, for example, via CRM systems 24, ERP systems 23, network management systems 25 and other types of contents and information (e.g., non-privileged content, web content 26), directly from their desktops using a myriad of Web 2.0 technologies, such as, for example, RSS readers 18, AJAX applications 29, gadgets and personalized homepages 19, instant messaging 27, and bookmarking and tagging applications 28. The system of the invention 20 supports secure access to privileged application data 22, both from within secured networks (e.g., corporate network), and externally (e.g., outside of the corporate firewall).

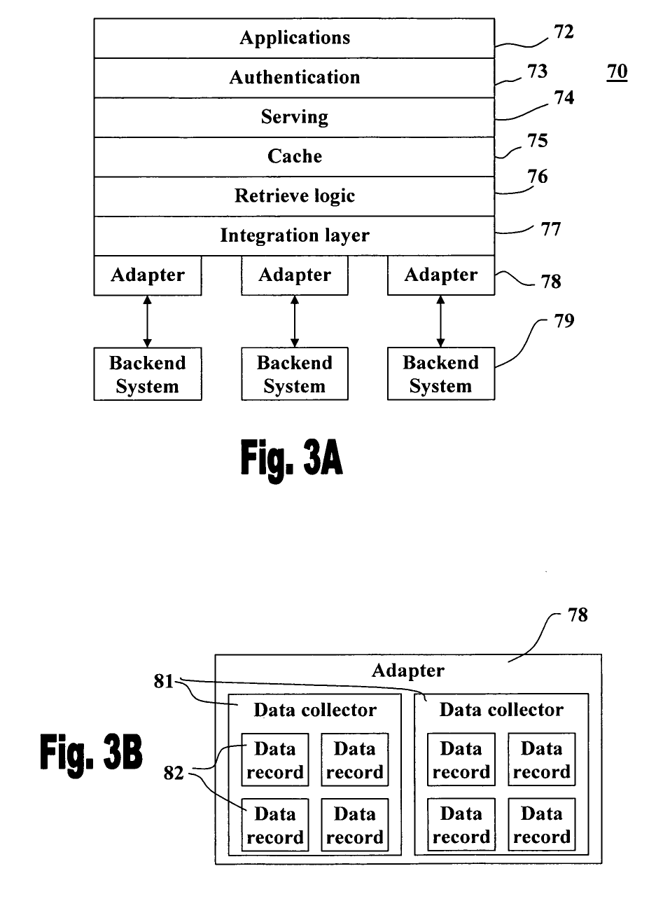

With reference to FIG. 3A showing a possible architecture 70 of the system of the invention, the system of the invention 70 allows access to data stored in various backend information systems 79 (e.g., enterprise information system). In order to provide this functionality, the system 70 periodically retrieves data from the backend systems 79 via adapters 78. To avoid generating excessive load on the backend systems 79, the system 70 implements an intelligent scheduling algorithm that determines when to perform data retrieval.

As exemplified in FIG. 3A, an adapter 78 is typically associated with a single backend system 79. With reference to FIG. 3B, adapter 78 comprises one or more data collectors 81, each of which is typically associated with a set of data items retrieved from the backend system 79 with which it is associated.

In determining when to perform retrieval, the system 70 takes the following user-defined parameters into account:

Polling frequency limits—users can define limits on the number of requests sent to a backend system 79 over a unit of time. Frequency limits are set both at the adapter (78) level and at the data collector (81) level. Different polling frequency limits may be set for different time intervals, for example, a certain limit may be set for Sundays between 10 PM and midnight, and a different limit may be set for weekdays during work hours, etc.
Update hints—users may be able to define when data from a data collector 81 or adapter 78 is typically updated. The system 70 uses this information to decide when it is most beneficial to retrieve data. For instance, many databases are updated once a day, usually during off hours, by a batch process. A user can define that data for a certain data collector 81 updates daily, for example, at 3:00 AM. The system will then schedule retrieval for that data collector daily just after 3:00 AM, minimizing the load generated on the backend system 79 and maximizing the time in which the retrieved data is up to date.

System 70 is designed to meet the following goals:
1. Security—system 70 should provide secure access to privileged data, for example, by applying data access controls and security policies that are at least as strict as those applied by the origin systems (i.e., the systems where the data was originally entered or generated, or where the authoritative version of the data is stored e.g., ERP 23, CRM 24 and NMS 25 systems).
2. Scalability—system 70 should scale to handle substantially great numbers of (millions) users without generating excessive load on backend systems.
3. Transparency—system 70 should allow uniform access to backend system data regardless of the origin system.
4. Universality—system 70 should not restrict the technologies used to implement applications or the backend systems 79 from which it collects data.

In order to achieve the above goals, the system architecture 70 adheres to the following principles:
Universal authentication (73): all connections to system 70 should be authenticated. This is critical in order to enforce access controls.
Decoupling data retrieval from data access: system 70 keeps a data cache 75 that allows serving requests for data from syndicated applications 72 without repeatedly accessing the backend systems 79. The cached data can be updated whenever appropriate, independent of the incoming application requests.
Uniform data representation: regardless of the origin system, data is represented internally as simple flat records.
Extensible access methods: the set of methods (e.g., HTML, RSS, JSON, XML over HTTP, XMPP, or other protocols and formats) in which syndicated applications 72 can access data is varied and easily extended.
Extensible backend adapters: the set of backend adapters 78 supported by system 70 is varied and may be easily extended.

Adapters 78 are used to manage the communication with backend systems 79 in which the privileged data is stored (e.g., enterprise information system). Adapters 78 can be defined for serving a specific syndicated application 72 (e.g. SAP adapter or a Siebel adapter) or can be generic, capable of supporting a widely used technology (e.g. RDBMS adapter or Web Services adapter).

Adapters 78 can be either synchronous or asynchronous. Synchronous adapters periodically poll backend systems 79 for data, pulling relevant information as it becomes available. An example of such an adapter is an RDBMS adapter that is adapted to periodically execute SQL queries on a backend database to retrieve data. Asynchronous adapters 78 subscribe to data streams from backend systems 79 and then have notifications pushed to them by the backend system 79. An example of an asynchronous adapter 78 is an MQSeries adapter which subscribes to topics and then processes messages that are pushed from the MQSeries backend.

Adapters 78 are responsible for managing the life cycle of the connections with backend systems 79. Determining what to retrieve and when to retrieve is the responsibility of the integration layer 77 and retrieve logic 76. System 70 may include a host of built in adapters 78, and it preferably defines a simple interface that adapters 78 must implement, allowing third parties to easily develop new adapters 78.

As shown if FIG. 3B, adapters 78 aggregate one or more data collectors 81. Preferably, each data collector 81 represents a different set of data records originating from a specific backend information system 79, which is associated with a specific adapter 78. For example, an RDBMS adapter may have several data collectors 81 each representing a different database query. An MQSeries adapter may have several data collectors each representing a different topic.

The integration layer 77 is responsible for representing (transforming) the data retrieved from backend systems 79. It implements a uniform model for all incoming data, regardless of the origin system. Data is modeled as data fields that are grouped together in data items. A data field represents a single data ‘atom’ that has a specific type, display name, constraints on possible values and so on. A data item represents a grouping of data fields into a record that generally represents an entity from the problem domain of the origin system such as a customer in a CRM system (24 in FIG. 2) or an inventory item in an ERP system (23 in FIG. 2).

Retrieve logic 76 uses adapters 78 in conjunction with the metadata defined in the integration layer 77 and the limits and hints defined for retrieval (as discussed hereinabove) to optimize data retrieval from backend systems 79 while adhering to user defined limits. Retrieve logic 76 also takes into account data usage patterns, giving priority to data that is accessed more frequently, and has the capability of retrieving only the data required by users, based on user defined parameters. For instance, in a scenario wherein system 70 provides access to stock quote information from a backend trading system, instead of retrieving and caching information for all stocks, retrieve logic 76 can use the stock ticker symbol as a parameter and retrieve quotes only for those stocks that have actually been requested by users.

The system stores data it retrieves from backed information systems 79 in a data item cache (in cache 75). The data item cache provides a uniform representation of all retrieved information, regardless of the source backend system 79, and the specific content of the data items. The cache 75 also enables decoupling between retrieval of data from syndicated applications 72 and access to data by clients. When a client requests data from system 70, the system can serve the data from the cache 75 and avoid generating unnecessary load on the backend information systems 79.

In situations wherein compliance considerations or corporate policy disallow the caching of some or all of the retrieved data, system 70 may be adapted to support a direct-access mode in which data is retrieved and processed on demand, and no data is cached within the system.

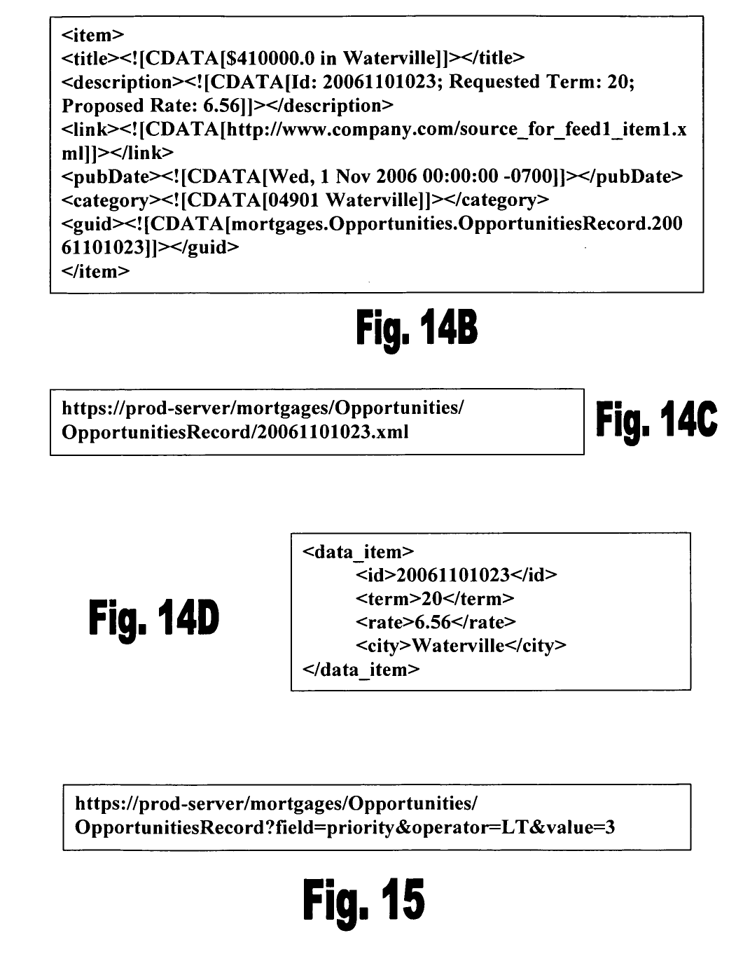

The serving component 74 is responsible for serving incoming requests for data. Client requests are generally incoming HTTP requests. Based on the URL the serving component 74 determines the data that should be returned and the representation of the requested data. For instance, a request for a data item representing an opportunity record originating from a bank's CRM system may be accessed through a URL such as exemplified in FIG. 14C. This indicates to the serving component 74 that it should return the identified record from the backend system 79 (either from the cache 75 or directly, based on the data source configuration) and that the data should be formatted as XML. Clients can request other formats such as RSS, HTML or JSON in a similar way.

A URL may also point to a set of data items. This is typically done by specifying a set of parameters that determine what subset of the data items the application server should return. For example, such URL may be in the form shown in FIG. 15, which indicates to the serving component 74 that it should return the set of opportunities records that have a priority of less than 3.

Serving requests, as is the case for all requests from system 70, are authenticated. System 70 uses the user identity associated with the request to apply access control restrictions to the underlying data as will be described hereinbelow, as well as to make the returned data user aware by filtering through only those data items relevant to the requesting user, based on the underlying metadata definitions.

In addition to providing clients with access to backend data, the serving component 74 also keeps track of the access statistics. Access statistics are used by retrieve logic 76 to prioritize data for retrieval.

Every access to system 70 is authenticated. System 70 does not manage a user directory by itself, but instead uses existing user (e.g., enterprise) directories and single sign on systems to authenticate users. Regardless of the specific authentication method used, every incoming request is associated with a user identity and additional user information from the user directory such as the names of groups the user belongs to and roles the user has within the organization.

Various components of system 70 may use authentication information to control access to data, carry out aggregations of data items associated with a user, collect usage statistics etc.

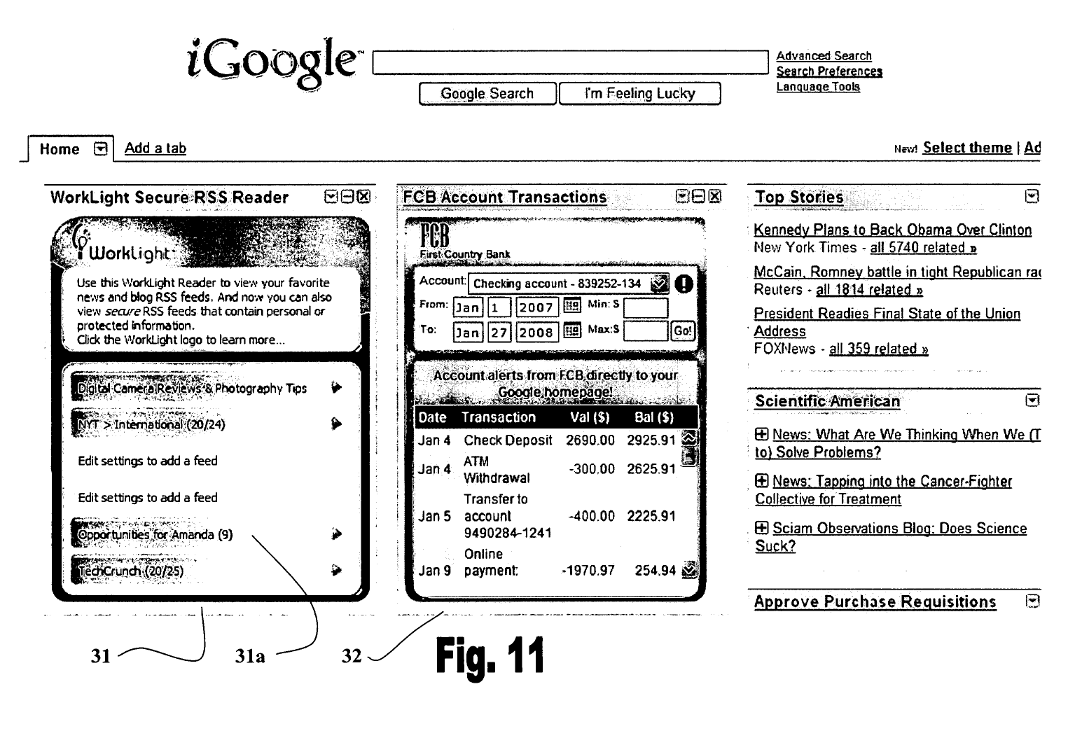

Syndicated applications 72 are the primary method for end users to interact with system 70. System 70 may come bundled with several applications 72, and may provide tools and APIs to allow third parties to develop new applications 72. The system's syndicated applications 72 allow viewing data items such as sales opportunities from a CRM system 24, executing transactions such as authorizing purchase requisitions in an ERP system 23 and much more. The system secure RSS Reader 31 depicted in FIG. 11 is an example of a possible syndicated application 72.

System 70 may include a consistency verifying component (e.g., in the integration layer 77) for executing operations on backend systems 79, which will be referred to hereinafter as ‘actions’ (e.g., Approval of a purchase requisition, update of reported work hours, change of status of a customer service request etc.). Since the data in the cache 75 may not match the state of the data in the backend systems 79 when such action takes place, it is critical to verify consistency of the cached data with the data in the backend systems 79 before executing such actions. Furthermore, the consistency verification and the action execution must occur within the scope of a single isolated transaction (i.e., a transaction that is not affected by any other concomitant process in the backend system) to ensure that the data associated with the action to be carried out was not changed in the backend system before action execution.

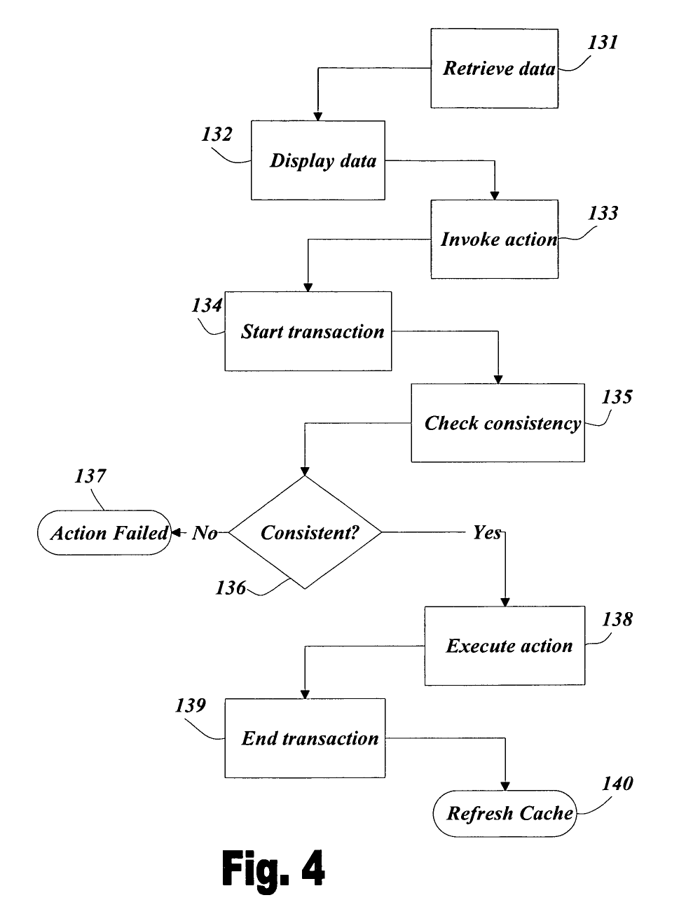

FIG. 4 is a flowchart illustrating action execution process according to a preferred embodiment of the invention. The process is initiated in step 131 when the syndication system 20 retrieves data from a backend system 79 (e.g., ERP systems 23, CRM systems 24, network management systems 25, or other web content 26, shown in FIG. 2). In step 132 a syndicated application 16 displays the retrieved data. Subsequently, in step 133 the user invokes the action from the syndicated application 16. In step 134 the syndication system 20 initiates a transaction in the respective origin backend system 79, and proceeds in step 135 to test the consistency of the data maintained in cache 75 with that stored in the respective backend system 79. If it is determined there is data consistency, the syndication system 20 proceeds to execute the action in step 138 and then ends the transaction in step 139. After the transaction is completed the syndication system 20 optionally refreshes the cache 75 in step 140 with the data that may have changed as a result of the executed action. If the consistency check fails, the action fails in step 137.

Application developers can use a system Software Development Kit to develop new syndicated applications 72. Using the SDK, application developers can quickly implement new ways to view existing privileged data or combine information from different backend systems 79 in new and useful ways that, without system 70 of the invention, would require long and expensive integration projects.

A typical implementation of the system involves retrieving privileged data via multiple syndicated applications and making it securely available to users by way of various access methods both from within the network of the organization to which the users belongs and from the Internet. As a result, security is a major consideration in the invention's system design.

Authentication services are preferably used to ensure that actors in the system are indeed who they claim to be. Authentication preferably involves authenticating the system server, authenticating the client used to access the system and authenticating the user making the access. Server authentication allows the client and the user to ascertain they are communicating with the system. Client authentication allows the server to ascertain that it is serving a known and certified client. User authentication allows the server to ascertain that it is serving a known user and to associate that user with appropriate privileges and optionally, with the client instance.

The authentication processes described above occur in sequence, and different authentication methods may be used for each process. At the end of the process, the system server is assured of the client's and user's identity and both the client and the user are assured of the server's identity.

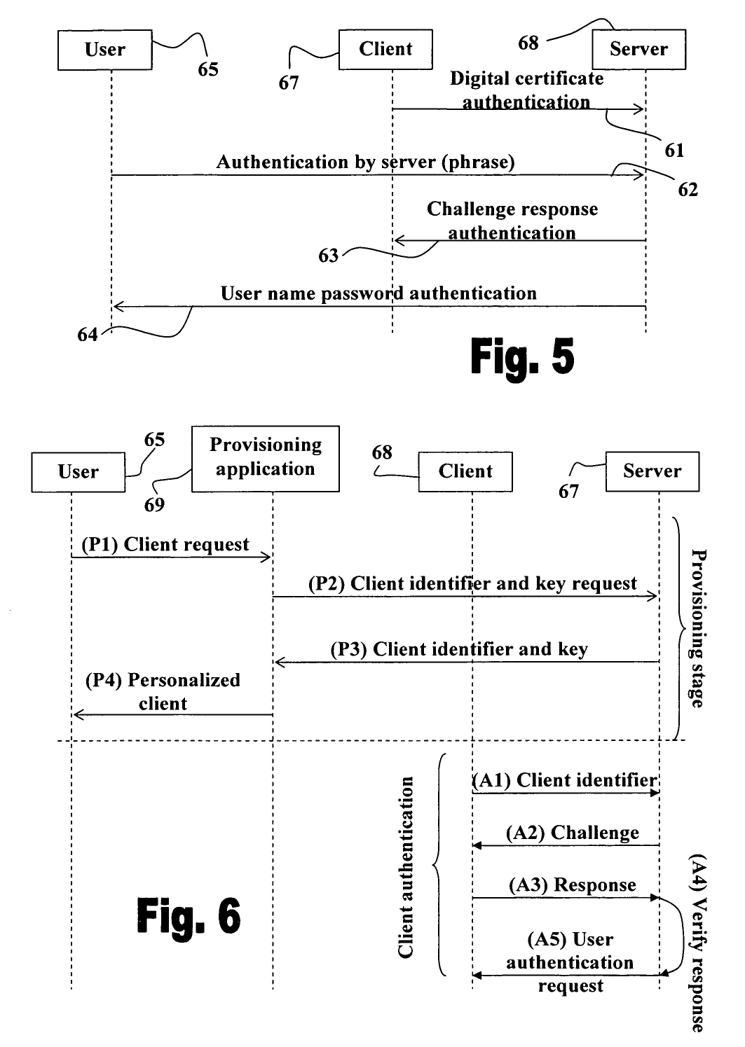

FIG. 5 shows authentication sequence between a user 65, user's client 67, and a web server 68 used in an implementation of system 70. Server 68 may authenticate itself (61) using SSL and digital certificates. In some cases, as in the case wherein a gadget is used as client 67, there is an increased risk of client impersonation. In such cases, system 70 can employ a server authentication phrase such that user 65 can visually authenticate server 68 before entering any personal identifiers, such as a password. Server 68 authentication phrase is a string assigned to user 65 during the application provisioning process. The string can either be generated by server 68 or entered by user 65. The string should be difficult to guess but easy for user 65 to verify. The server 68 sends the authentication phrase to the client 67 after digital certificate authentication (61) of server 68 and client 67, but before requesting user authentication (64). The client 67 displays the server authentication phrase as part of the user authentication (62) dialog. Users 65 should not enter their password before verifying the server authentication phrase (62).

In cases wherein there is a high risk of attacks that attempt to impersonate client 67, server 68 employs a client authentication mechanism. This mechanism may be required, for example, when the client 67 used for accessing privileged content stored in backend systems 79 is a desktop or homepage gadget (a mini application, usually written in Javascript, running in a Web browser or a gadget-specific runtime environment). Accessing the source code of such applications and modifying it is relatively simple, thus increasing the risk of attempts to impersonate client 67.

The preferred method for client authentication is client certificates, but in many cases, the complexity of secure certificate distribution and management outweighs the security benefits achieved. In order to authenticate clients 67 without digital certificates, server 68 preferably issues a unique identifier to each client 67 instance during the provisioning process (initiated from a secure provisioning application as described with reference to FIG. 6), along with a shared key. The client instance identifier and the key are associated with the user 65 accessing the service and stored in a user database, maintained on the server 68 (for server 68) and on the persistence service provided by the aggregation site (for client 67). As part of the authentication process, the client 67 sends to server 68 its client identifier and then server 68 and the client 67 execute a challenge-response protocol (63) with the client key as the shared secret. Following successful authentication of the client instance 67, server 68 authenticates user 65 by means of a user name and password over a secure connection, or by using a challenge response protocol with the password as the shared secret.

The diagram shown in FIG. 6 schematically illustrates a typical client instance identifier provisioning and a client authentication process according to a preferred embodiment of the invention. Specific implementation details may vary based on the capabilities of client 68 being used, the network architecture and the security requirements. The provisioning application 69 in FIG. 6 is preferably a type of existing trusted secured application used as the starting point for the provisioning process. This may be an existing Web application such as a secure banking application or a special purpose secure client provisioning application. The authentication process in the provisioning stage preferably comprises the following steps:

(P1) Client Request: In this step, the user 65 requests to download a client 68 from the secured provisioning application 69.
(P2) Client Identifier and Key Request: The provisioning application 69 requests a client identifier and a key (to be used as a shared secret) for the client instance (68) it is provisioning.
(P3) Client Identifier and Key: server 67 returns the requested client identifier and key to the provisioning application 69.
(P4) Personalized Client: The provisioning application 69 generates a personalized client instance 68 with the identifier and key it received and returns it to the user 65. This step finalizes the provisioning stage.

The client authentication steps after completing the provisioning stage may be performed as follows:

(A1) Client Identifier: client 68 sends the client identifier to server 67.
(A2) Challenge: the server 67 sends a random challenge to the client 68.
(A3) Response: client 68 calculates a cryptographic hash function of a combination of the challenge and the key and sends the result to the server 67.
(A4) Verify Response: server 67 verifies that the response sent from client 68 is indeed the correct hash value. This step finalizes the client authentication phase.
(A5) User Authentication Request: server 67 proceeds to user authentication (described with reference to FIG. 5).

In most cases, user authentication is performed by requesting a user name and password from user 65, over a secure connection (64 in FIG. 5), and verifying the same against a user directory maintained by the application provider. This process can be performed by server 67 itself or by existing authentication tools and single sign-on system already deployed in the organization. Server 67 may support simple integration with such systems by implementing the appropriate JAAS login modules.

While user name and password authentication is the most common user authentication mechanism, other mechanisms can be supported. By integrating with external authentication systems server 67 can support authentication methods such as digital certificates, one time passwords, hardware tokens, biometrics and many others.

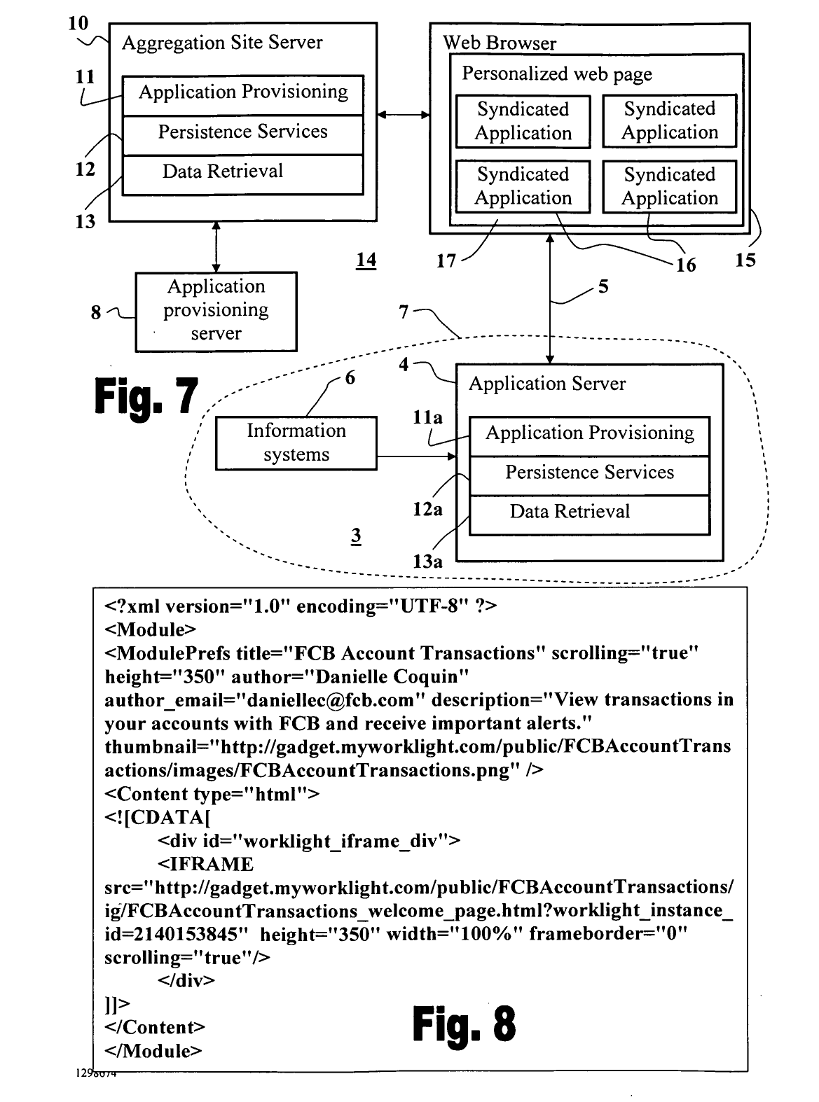

FIG. 7 is a block diagram schematically illustrating a preferred embodiment of a system 14 of the invention which allows secure provisioning of syndicated applications. In order to provide a framework for secure application syndication within the existing infrastructure of aggregation sites, system 14 provides a set of services that is, for the most part, equivalent to the services provided by aggregation sites but which may be accessed over a secured link 5, and which advantageously resides in a secure environment 7 e.g., firewall, or other such network security means. Additionally, system 14 provides a method for provisioning secured syndicated applications on any aggregation site in a way that is largely independent of the site's specific requirements on syndicated applications 16.

An application server 4, running in a secure environment 7 (e.g., behind the application provider's firewall) provides the syndicated applications 16 with the services they require. Analogous to the services provided by the aggregation site server 10, the application server 4, provides application provisioning 11a, data persistence 12a and data retrieval 13a services. The application server 4 also facilitates secure user authentication by integrating with the authentication infrastructure of application provider 3.

Secure application provisioning provides the application provider 3 with control over where syndicated applications 16 are installed and by whom. Additionally, by using an external application provisioning server 8, accessible from the aggregation site servers 10, the application provider 3 avoids the need to allow aggregation site services (11, 12 and 13) to access resources within the application provider's secure network 7.

The goal of the provisioning process of the invention, inter alia, is to add an application wrapper to the user's personalized web page 17. The application wrapper (not shown) includes public information about the requested syndicated application, such as, for example, the application's title and author. The wrapper structure is specific to the aggregation site (17). The wrapper causes the site to render an ‘inline frame’ (an HTML element that causes a web browser to render a nested frame within a web page that contains an html document different and separate from the document displayed in the web page. The inline frame source attribute contains the URL of the nested document.) sourced from the application server 4. The requested syndicated application is then loaded by the browser 15 from the application server 4 into the inline frame over secure connection 5. FIG. 8 exemplifies a possible application wrapper for the iGoogle aggregation site, for example.

The secure provisioning process of the invention also serves in associating a unique, high entropy identifier with the provisioned syndicated application instance. This identifier is associated with the identity of the user to whom the application is provisioned, so that attempts of other users to use the same application instance will fail. This identifier is stored both in the application wrapper and in the aggregation service's persistence mechanism 12. The syndicated application 16 compares the values stored in each of these locations every time it is executed to verify that the provisioned application instance is running within the intended aggregation environment.

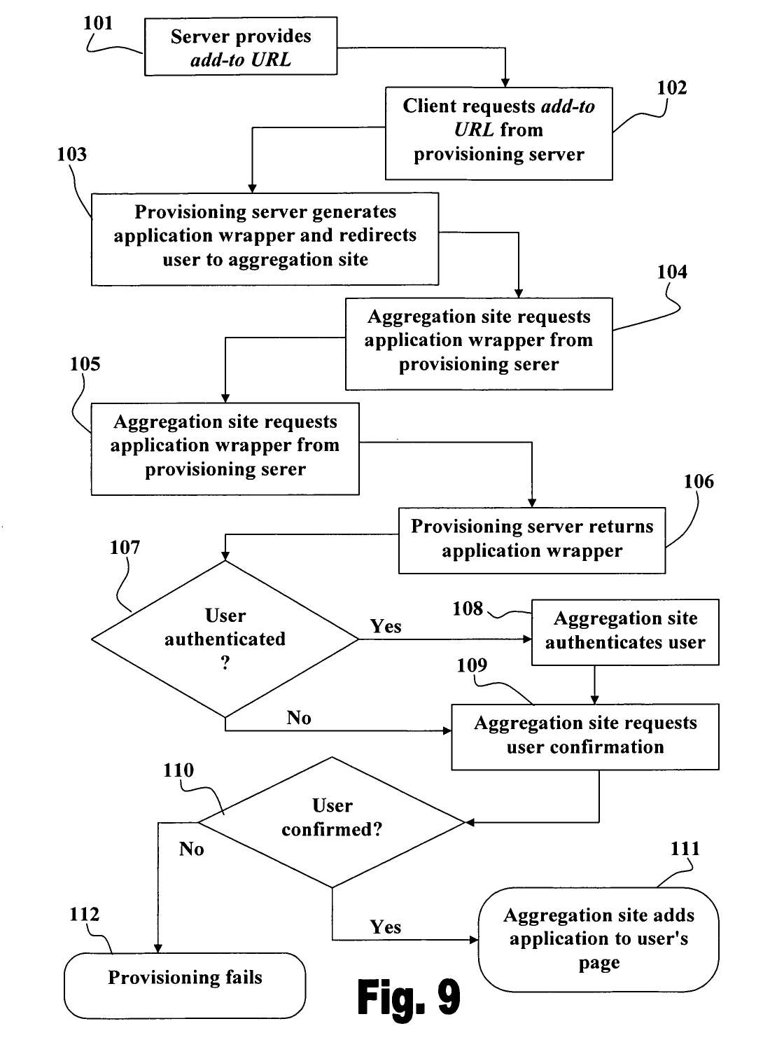

FIG. 9 is a flowchart illustrating the provisioning process of the invention. The process is initiated in step 101 when application server 4 provides the client (e.g., web browser 15) with an Add-to URL. The provided URL points to application provisioning server 8 and specifies an application instance identifier as well as the aggregation site (e.g., personalized web page 17) to which the syndicated application (16) is to be added. The URL preferably contains a unique, high-entropy application instance identifier. The instance identifier is associated with the identity of the user provisioning the syndicated application, as provided by the application provider's authentication infrastructure which will be discussed hereinbelow. The URL may also contain detailed information about the contents of the application wrapper for the target aggregation site server 10.

In step 102 the client (e.g., web browser 15) requests the resource identified by the URL from the application provisioning server 8. In step 103 the application provisioning server 8 generates the appropriate application wrapper and redirects the client (15) to aggregation site server 10 with an Add-to URL formatted according to the specifications defined by the target aggregation site and pointing to the application wrapper as the target application. In step 104 the client (15) requests the resource identified by the URL from the aggregation site server 10. In step 105 the aggregation site server 10 requests the application wrapper from the application provisioning server 8, wherein said request contains the application instance identifier.

Next, in step 106 the application provisioning server 8 returns the appropriate application wrapper. The instance identifier is stored within the application wrapper and appears on all requests for the syndicated application 16.

In steps 107 and 108 the aggregation site server 10 authenticates the user, if the user is not yet authenticated, and in steps 109 and 110 the aggregation site server 10 requests the user's confirmation to add the syndicated application to the user's profile. If the user confirms to add the syndicated application, in step 111 the aggregation site adds the syndicated application to the user's profile, otherwise the application provisioning fails as the control is passed to step 112. After step 111 the user is able to use the syndicated application 16 by means of the application wrapper maintained in the aggregation site server 10, by addressing the requested application based on the code in the application wrapper and accordingly securely downloading the requested application from application server 4 over secure connection 5.

The secure data persistence service 12a (FIG. 7) allows syndicated applications 16 to store data per syndicated application instance. Syndicated applications 16 store and retrieve specific data items by specifying a key and either requesting or setting the value associated with the key. The application server 4 automatically accesses the correct data store based on the syndicated application instance 16 making the request. The data itself is stored securely within the application provider's network 7 and is fully under the application provider's control. Syndicated applications 16 may specify the scope of the persistent data making it available to the current syndicated application instance only, all the user's instances of the application, or to all the user's syndicated applications. This allows multiple instances of the same syndicated application 16 run by the same user and/or different syndicated applications 16 run by the same user to share data between them. Persistence services 12a are provided over an encrypted connection 5 and only after the user has been securely authenticated.

The secure data retrieval service 13a allows syndicated applications 16 to retrieve data from sources within the application provider's secure network 7 as well as public Web resources. The application server 4 is integrated with the application provider's information systems 6 and provides a query interface that allows syndicated applications 16 to request data from the information systems 6 in a uniform way. To retrieve Web resources, the syndicated application 16 specifies the target URL in the retrieval request. Data retrieval services 13a are provided over an encrypted connection 5 and only after the user has been securely authenticated.

Users may access a syndicated application 16 only after being securely authenticated by the application provider 3. Because the application provider's authentication infrastructure is used, the syndicated application 16 benefits from any security features in the provider's authentication process such as password change policy, password entropy rules and multi factor authentication. This authentication is independent of authentication carried out by the aggregation site server 10, which is typically required by the aggregation site server 10 for personalization, but does not affect the security of the syndicated application 16.

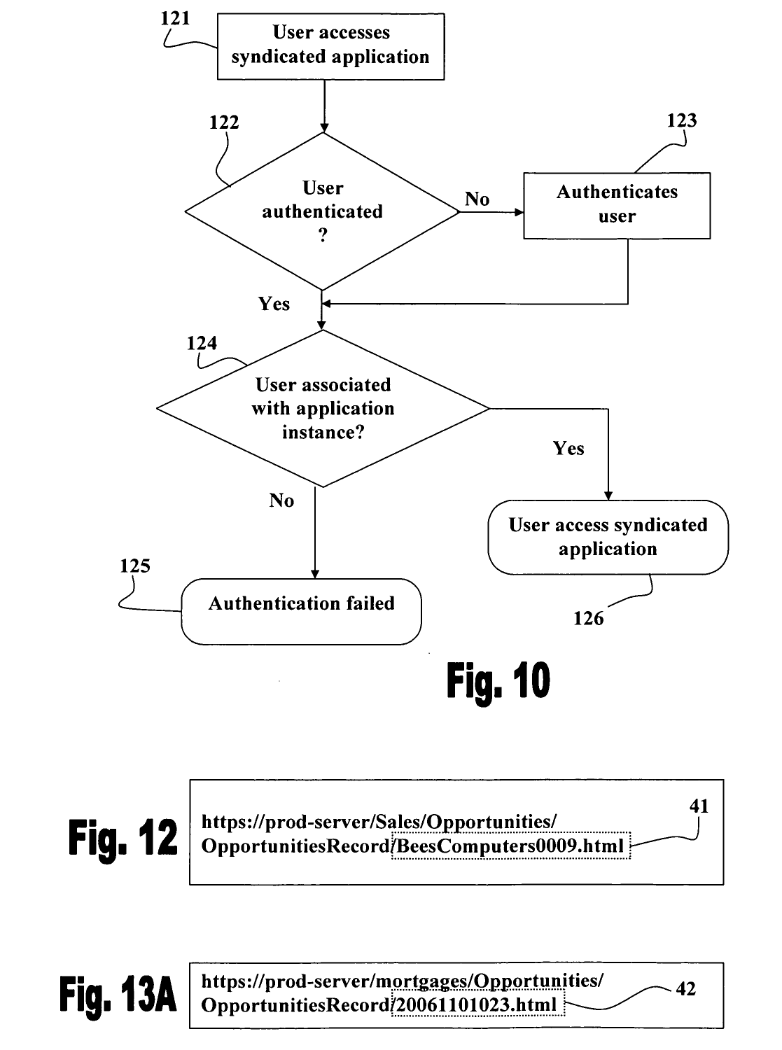

FIG. 10 is a flowchart illustrating a user authentication process according to a preferred embodiment of the invention. The user authentication process is initiated in step 121 when the user requests and accesses the syndicated application 16. Typically, this occurs when the user accesses an aggregation site to which the syndicated application 16 has previously been provisioned e.g., user's personalized web page 17.

If the resources where the syndicated application 16 resides are available to the user, in step 122 the security mechanisms governing access to those resources verify that the user is authenticated.

If the user is not authenticated, the aforementioned mechanisms authenticate the user in step 123. This authentication may occur completely outside the context of the syndication system of the invention as long as the user's authentication state and the user's identity can be securely transferred between the authentication mechanisms and the application server 4.

In step 124 the application server 4 verifies that the authenticated user is the user associated with the syndicated application instance identifier. If the authenticated user is not the one associated with the instance identifier, in step 125 the user is denied access to the application. If the authenticated user is associated with the instance identifier, in step 126 the user is successfully authenticated and may access the secure syndicated application.

FIG. 11 shows an exemplary syndicated application of the invention wherein the privileged content is securely accessed via Google Personalized Homepage employing the secured syndication scheme of the invention (e.g., secured RSS Reader). In this example the secured RSS reader 31 is used for accessing and displaying privileged content, and a bank account transaction application 32 to view bank transactions from a banking system.

A basic capability of the system of the invention, on which many features are based, is the capability to assign a unique URL to privileged data entities (e.g., enterprise data). Conveniently, the system assigns a URL to all privileged data items that it is configured to retrieve. The URL of a privileged content item uniquely identifies the item, such as exemplified in FIG. 12, wherein the privileged content in HTML file 41 may be accessed through the URL link e.g., by clicking the item referencing the URL, for example item 31a in FIG. 11.

Any user can request privileged data items, but only users having appropriate access privileges can access the requested items. Other non-authorized users receive an appropriate error message whenever attempting to access such privileged content.

The system of the invention may also assign URLs to sets of privileged data items. Such sets are defined by assigning values to parameters. For instance, a user can request to access items in the opportunities table wherein the projected revenue is above a certain threshold.

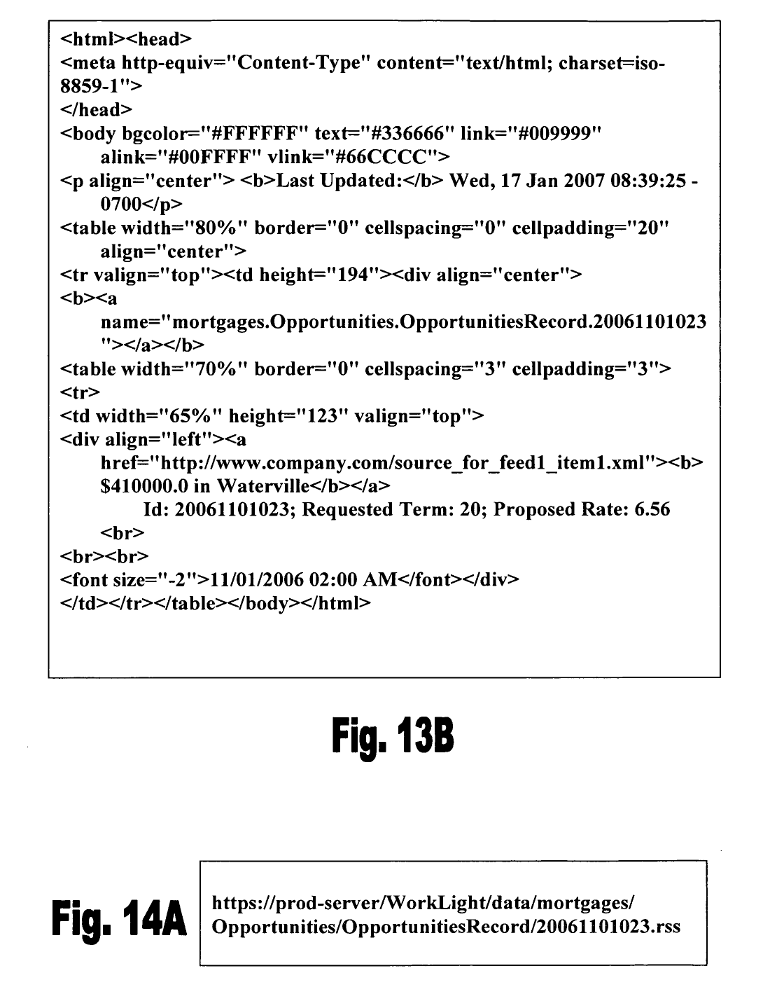

The secured syndication system of the invention is preferably adapted to support multiple representations of privileged content. These include HTML, RSS, JSON and XML. Based on the user's request received in the system, the content is transferred to the user in the appropriate format. For example, a request for the HTML representation of an opportunity from a bank's CRM system may be in the form of a URL referencing a HTML file 42, as exemplified in FIG. 13A, and the requested data is typically provided in form of HTML content, as exemplified in FIG. 13B. The URL for the same item represented as RSS feed may be in a form similar to that exemplified in FIG. 14A, and the resulting RSS item may be provided in a form similar to that exemplified in FIG. 14B. Similarly, for plain XML, the request may be in the form exemplified in FIG. 14C, and the requested content may be provided in a form similar to that demonstrated in FIG. 14D.

An additional benefit of assigning URLs to the privileged data items is the resulting ability to store the URLs in bookmarking systems, tag the URLs and share the URLs by simple existing mechanisms such as email or instant messaging. The system of the invention may be adapted to keep track, internally, of the data items accessed by users of the system and can provide information regarding user's most commonly accessed data items, what users of a similar profile (e.g. members of the same department) access, what additional information may be of interest to a user based on the data already accessed by the user, and other users' usage information etc.

The system of the invention may further allow assigning tags to items, rating items, and may support searching and sorting based on these values. Any item or set of items can be tagged or rated, providing user generated metadata that can significantly reduce the time it takes to find the information the user is looking for.

The system of the invention may be further adapted to provide users with the information most relevant to them. This may be advantageously achieved by employing RSS feeds wherein the data in the feed depends on the identity of the user accessing the feed. For example, two sales managers accessing a ‘My Opportunities’ feed containing opportunity information originating from a CRM system (24 in FIG. 2) would both use the same URL (e.g. https://prodserver/WorkLight/feed/MyOpportunities), but access to the opportunity information items will be allowed only to the opportunity items assigned to each user.

The mechanism underlying this functionality uses information retrieved from a user directory regarding the groups a user belongs to (e.g., such as in enterprises—teams, departments etc.) and information from an information system regarding ownership of data items (e.g. the identity of the sales executive assigned to an account) to determine what items to include in the returned data. The implementation of these features will be further described hereinbelow.

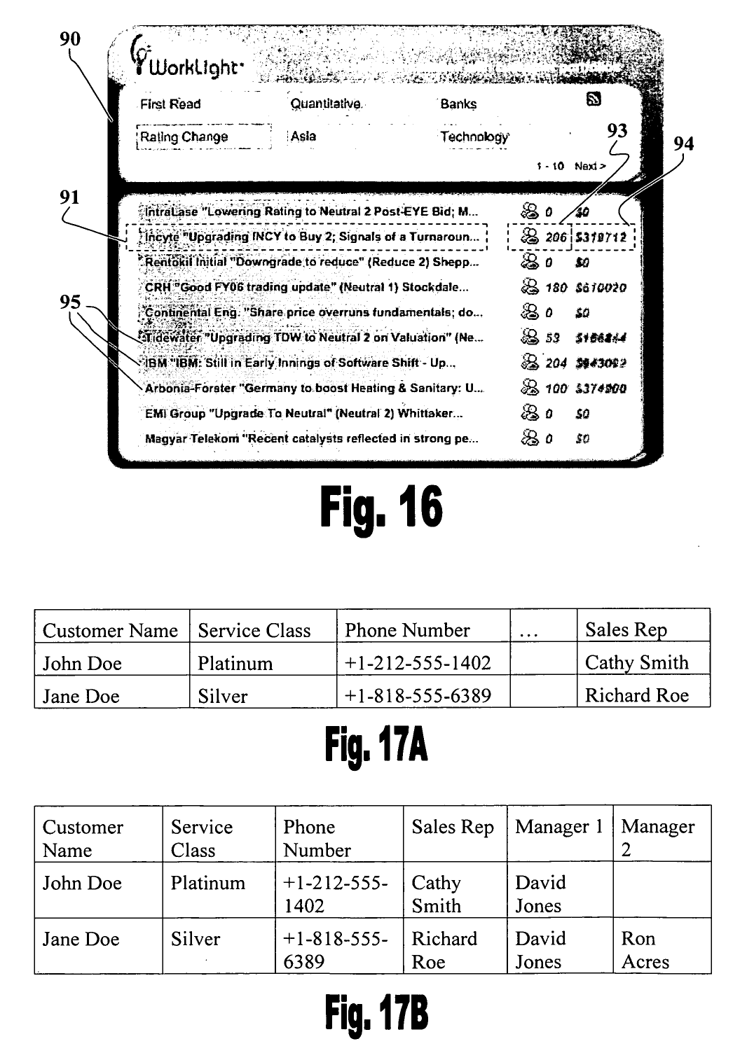

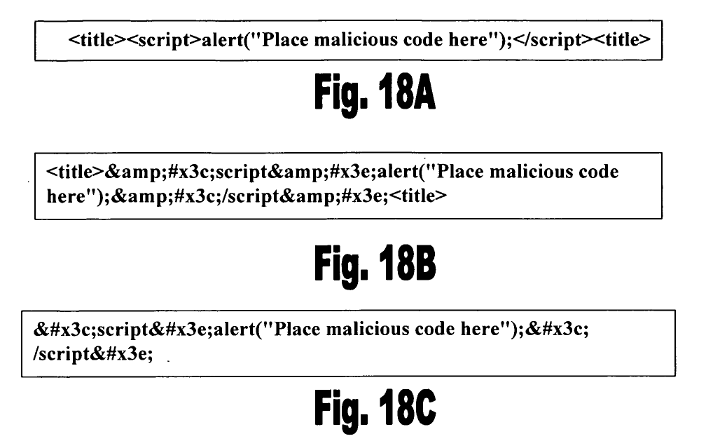

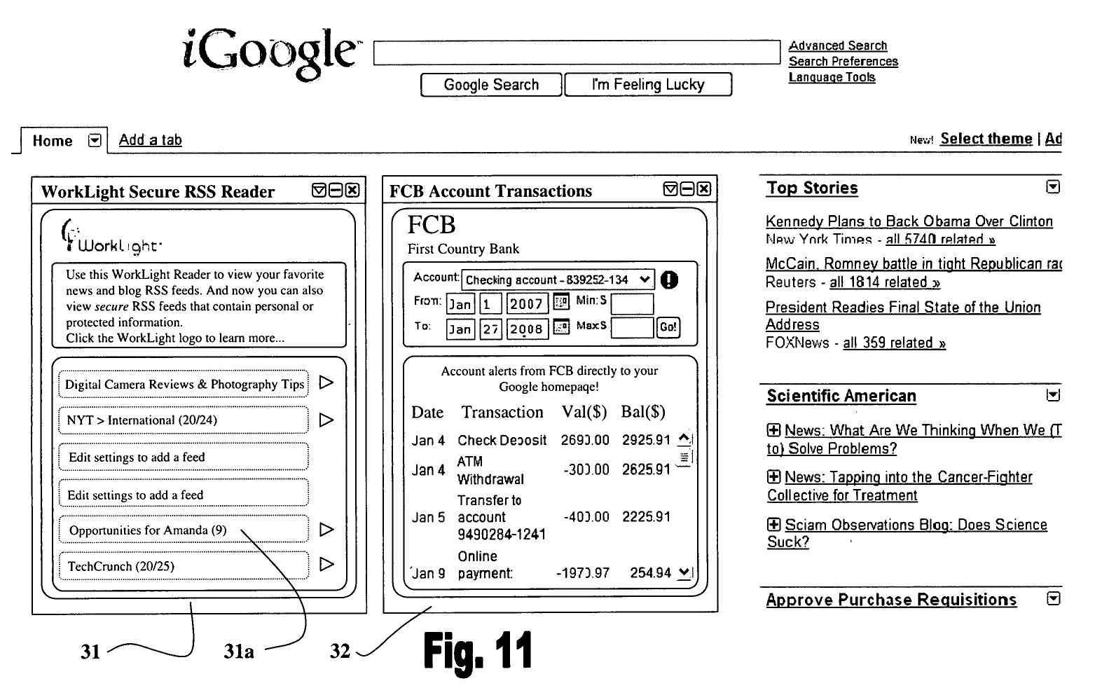

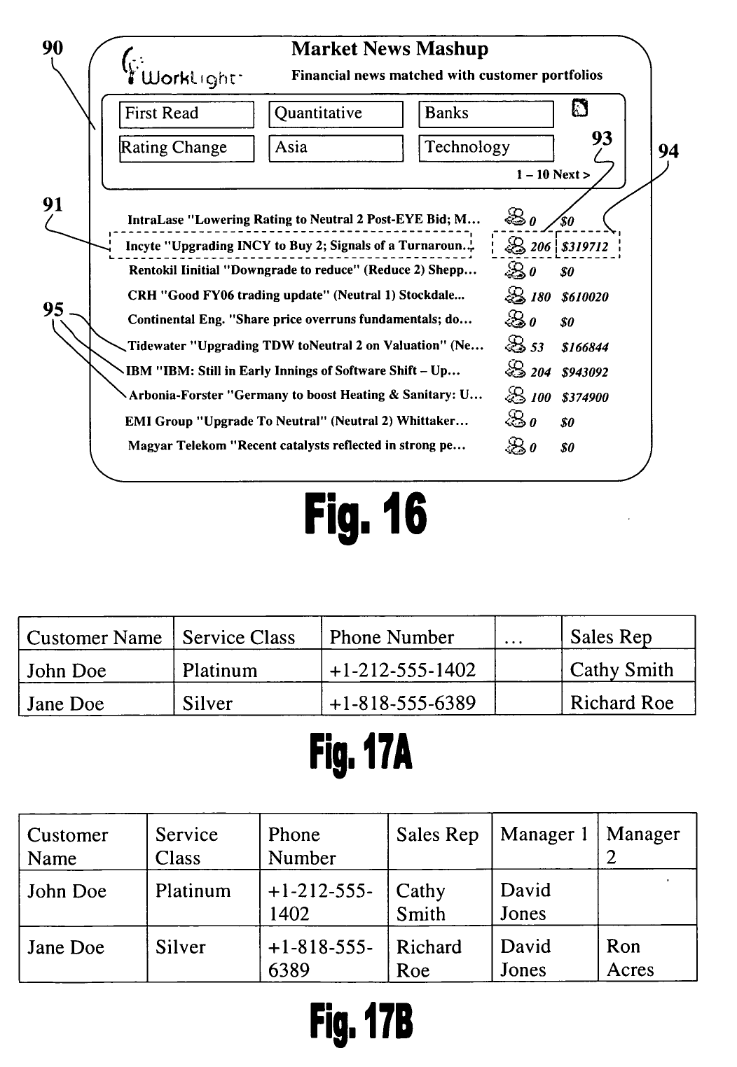

FIG. 16 shows a possible mashup application 90 combining data from the Web 95 and privileged applications content 91 (e.g., showing the number of customers with related stock 93 and amount of bank holdings in related stock 94, obtained by means of a syndicated application 72).

A major consideration when accessing secure privileged content (e.g., enterprise data) is access control. It is critical that users gain access only to data items they are authorized to access by their organization's security policies. In most large organizations, access control rules are not centrally managed. Rather, they are implemented separately by each enterprise information system. In some cases, the systems' access control logic applies to users defined in a central user directory, while in other cases, the information system manages its own separate user database. Within these constraints, the system of the invention implements a mechanism that integrates information from central user directories and the organization's information systems and integrates this information in a manner that allows it to enforce the same access control constraints the enterprise application system implements without explicitly duplicating the access control logic.

At the most basic level, the system of the invention implements access control by associating user principals with data items the system retrieves. User principals are identities the user is associated with such as user identifiers, group identifiers and role identifiers. When a user requests access to a data item, the system checks the principals associated with that data item against the principals associated with the user in the user management system (a user directory, user information specific to the origin system, or a combination thereof). In the simplest scenario, if at least one of the principals associated with the data item appears in the user's list of principals, the system allows access to the data item. Otherwise, the system denies access. The system can also implement more complex logic requiring multiple matches and requiring specific principals to appear or to match.

Associating principals with retrieved data items can be as simple as defining one of the item's fields as the principal, but may also be very complicated and require interaction with multiple systems and implementation of system-specific logic. A typical use case could be to implement access control for customer data in a CRM system. As part of the customer data, the CRM system includes the user name of the sales representative assigned to the customer. The corporate security policy mandates that only the sales representative and the representative's manager are allowed to access the customer's information. The hierarchy of the sales organization is described in the corporate user directory.

An exemplary customer database is shown in FIG. 17A. This example is based on sales organization hierarchy represented in the organization's user directory, which may be structured as follows:

### David Jones, VP Sales

Ron Acres, Sales Director
   Richard Roe, Sales Manager
Cathy Smith, Sales Director

A simplified representation of the data item as it appears in the system's cache is exemplified in FIG. 17B. Accordingly, John Doe's information will be accessible to David Jones and Cathy Smith, and Jane Doe's information will be accessible to Richard Roe, David Jones and Ron Acres, as mandated by the organization's access control policy. The specifics of how the data is gleaned are dependent on the information systems involved and the deployed user management infrastructure in the organization. The system allows implementing specific logic for this functionality and integrating it with the system.

Cross site scripting is an attack that attempts to inject malicious scripts into a context where they would be trusted by the browser and executed. When displaying data retrieved from enterprise applications, cross site scripting may occur, for instance, if the raw data retrieved from enterprise information systems contains malicious scripts. If this data were to be naively rendered in an environment that supports the script's language (e.g. a Web browser), the environment would execute the malicious code.

To thwart cross site scripting attacks, the system of the invention processes the data received from the enterprise system and removes elements that could potentially be interpreted as malicious scripts. Specifically, for data that is to be rendered in a Web browser, the system strips all HTML tags except for a short list of tags that are considered safe such as <b> indicating bold text, <i> indicating italics and <br> indicating a line break. The system also strips all attributes of the allowed tags. As a second layer of protection, the system escapes all text that remains between the safe tags after stripping, so that even if malicious code somehow leaked through the stripping process, it would be treated as literal text rather than as code by the execution environment.

For instance, the title of a feed containing a malicious script may be as shown in FIG. 18A. The stripping functionality would, in this case, strip out the section beginning with <script> and ending with </script> inclusive, so that the title would remain empty and the script would not be rendered.

A somewhat more complex example may be attempting to avoid stripping by escaping the element delimiters. An attempt to do this is exemplified in FIG. 18B. The escape sequence “&amp;#x3c;” represents the ‘<’ character and the escape sequence “&amp;#x3e;” represents the ‘>’ character. In this scenario, the stripping functionality of the system will not strip the malicious code, but it will escape the malicious code so that it is interpreted as literal text by the browser rather than as code. The rendered title would then look as exemplified in FIG. 18C, and as in the previous case discussed hereinabove, the browser does not execute the malicious code.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A syndication system for securely adding syndicated applications to conventional syndication aggregation sites and servers being accessible by user's client applications, comprising: an application server adapted to provide said syndicated applications to said client applications of authenticated users, one or more secured communication links between said client applications and said application server, and a provisioning server capable of generating and providing said syndication aggregation sites an application wrapper responsive to a request from user's client application, wherein said request and said application wrapper comprise unique identifiers referencing the requested application and the user requesting the applications.

2. The syndication system according to claim 1, wherein the application server resides within a secured network.

3. The syndication system according to claim 2, further comprising information systems residing within the secured network and capable of being accessed by the syndicated applications via the application server.

4. The syndication system according to claim 3, wherein the application server comprises: the syndicated applications; means for authenticating the users and the user's client applications; data persistence means for persisting data across aggregation site sessions; retrieval means for allowing the syndicated applications to request network resources through said application server; cache memory for storing data which has been previously requested by syndicated applications; serving means for serving incoming requests for data; and data collecting means capable of periodically and/or continuously retrieving privileged, or non-privileged, data from the information systems.

5. The syndication system according to claim 4, wherein the application server further comprises transformation means for providing the data retrieved from the information systems in a proper data representation.

6. The syndication system according to claim 3, wherein the application server further comprises data consistency means for verifying that the data items stored in the cache are updated with the last changes made in the information systems.

7. The system according to claim 4, wherein the data collecting means are implemented by data adapters.

8. A method for securely adding a syndicated application to user's aggregation site maintained in an aggregation site server and being accessible by a user client application, comprising: providing said client application addressing data comprising a link to a provisioning server and identifiers associated with said user and with said syndicated application; providing said aggregation site server a request to add said syndicated application, wherein said request comprises said addressing data and said identifiers; forwarding said request to said provisioning server; upon receipt of said request by said provisioning sever generating an application wrapper comprising said identifiers and addressing data referencing a location of said syndicated application in an application server; providing said application wrapper to said aggregation site server; and determining whether said user is an authorized user, and if so adding said application wrapper to said aggregation site, thereby allowing said client application to fetch said syndicated application over a secured link connecting it to said application server, according to the data contained in said application wrapper.

9. A method according to claim 8, wherein the addressing data is provided by the application server.

10. A method according to claim 8, wherein the request further comprises data referencing the aggregation site to which the syndicated application should be added.

11. A method according to claim 9, wherein the addressing data is provided in a form of an add-to URL.

12. A method according to claim 8, wherein the application server resides within a secured network.

13. A method according to claim 12, wherein the secured network further comprises information systems accessible by the syndicated applications provided by the application provider over the secured data connection.

14. A method according to claim 8, wherein the communication between the client application and the application provider is performed after authenticating the client application, the application server, and the user.

15. A method according to claim 14, wherein the server authentication is performed by the client application by means of SSL and digital certificates.

16. A method according to claim 14, wherein the server authentication is performed by the user by means of an authentication phrase.

17. A method according to claim 14, wherein the user is authenticated by the application server by means of user name and password.

18. A method according to claim 8, wherein the client application is a personalized client generated by a secured provisioning application by means of a client identifier and/or key provided by the application server.

19. A method according to claim 18, wherein the authentication of the personalized client by the application server comprises execution of a challenge-response protocol by the server and the client employing the key as the shared secret.
